(19) United States
(12) Patent Application Publication
(10) Pub. No.: US 2016/0181653 A1
(43) Pub. Date: Jun. 23, 2016

(54) FLEXIBLE ELECTRODE ASSEMBLY AND ELECTROCHEMICAL DEVICE INCLUDING THE SAME

(71) Applicant: Samsung Electronics Co., Ltd., Suwon-si (KR)

(72) Inventors: Sangmin Ji, Yongin-si (KR); Junhwan Ku, Seongnam-si (KR); Jeongkuk Shon, Hwaseong-si (KR); Minsang Song, Seongnam-si (KR); Moonseok Kwon, Hwaseong-si (KR); Jaeman Choi, Seongnam-si (KR); Seungsik Hwang, Seongnam-si (KR)

(21) Appl. No.: 14/803,241

(22) Filed: Jul. 20, 2015

(30) Foreign Application Priority Data
Dec. 23, 2014 (KR) 10-2014- 0187508

(51) Int. Cl. H01M 10/04; H01M 2/02

(52) U.S. Cl. CPC H01M 10/0436; H01M 2/0275; H01M 2220/30

(57) ABSTRACT

An electrode assembly includes at least one first electrode plate; at least one second electrode plate facing the at least one first electrode plate; a first separation film of which a surface thereof is bonded to the at least one first electrode plate which faces the at least one second electrode plate; and a second separation film of which a surface thereof is bonded to the at least one second electrode plate which faces the at least one first electrode plate. The first separation film and the second separation film of which surfaces thereof are bonded to the first electrode plate and the second electrode plate, are disposed between the first and second electrode plates facing each other.

### CROSS-REFERENCE TO RELATED APPLICATIONS

This application claims priority to Korean Patent Application No. 10-2014-0187508, filed on Dec. 23, 2014, and all the benefits accruing therefrom under 35 U.S.C. §119, the disclosure of which is incorporated herein in its entirety by reference.

### BACKGROUND

1. Field

Provided are an electrode assembly, and more particularly, a flexible electrode assembly and an electrochemical device including the same.

2. Description of the Related Art

With the technological advances in the field of electronic devices, the markets for mobile electronic devices have rapidly grown. Mobile phones, game machines, portable multimedia players (“PMPs”), MPEG audio player-3 (“MP3”) players, smartphones, smart pads, electronic book (“e-book”) readers, flexible tablet computers, wearable medical devices, and the like have been extensively developed and widely used. As the markets for mobile electronic devices have grown, there has been an increasing need for batteries suitable for driving the mobile electronic devices. In addition, there has been an increasing need for electronic devices that can be flexed during use and remain flexed, and that are flexible to be resistant to impact thereto. In such circumstances, the flexibility of batteries employed in such flexible electronic devices also has been required.

Unlike a primary battery, a secondary battery refers to a battery that is chargeable and dischargeable. In particular, a lithium secondary battery provides a relatively higher voltage and has a relatively higher energy density per unit weight than a nickel-cadmium battery or a nickel-hydrogen battery. Thus, the demand for the lithium secondary battery has tended to increase. Additionally, where a battery having insufficient flexibility is deformed such as to be bent, the durability and stability of the battery having insufficient flexibility may be deteriorated.

### SUMMARY

Provided are a flexible electrode assembly and an electrochemical device including the same.

According to an exemplary embodiment, an electrode assembly includes: at least one first electrode plate; at least one second electrode plate facing the at least one first electrode plate; a first separation film of which a surface thereof is bonded to the at least one first electrode plate which faces the at least one second electrode plate; and a second separation film of which a surface thereof is bonded to the at least one second electrode plate which faces the at least one first electrode plate. The first separation film and the second separation film of which surfaces thereof are respectively bonded to the first electrode plate and the second electrode plate, are disposed between the first and second electrode plates facing each other.

The first electrode plate and the second electrode plate may each have flexibility.

Each of the first electrode plate and the second electrode plate may include a current collector and an electrode active material which is on at least one surface of the current collector.

A bonding of the first electrode plate to the first separation film and a bonding of the second electrode plate to the second separation film may include an adhesive layer disposed between a respective electrode plate and a respective separation film or a direct bond between a respective electrode plate and a respective separation film.

For the first separation film bonded to the first electrode plate, a bonding area may be defined on at least a portion of the surface of the first separation film which is bonded to the first electrode plate, and for the second separation film bonded to the second electrode plate, a bonding area may be defined on at least a portion of the surface of the second separation film which is bonded to the second electrode plate.

The electrode assembly may further include at least one third separation film between the first separation film and the second separation film disposed between the first and second electrode plates facing each other.

The electrode assembly may further include a protection layer provided on an outer surface of at least one of the first and second electrode plates.

A bending stiffness of the protection layer may be greater than an average bending stiffness of the first and second electrode plates and of the first and second separation films.

The electrode assembly may further include a binding member which binds a portion of at least one of the first electrode plate, the first separation film, the second electrode plate and the second separation film.

The binding member may bind one end of at least one of the first electrode plate and the first separation film, and the binding member which binds the one end of the least one of the first electrode plate and the first separation film further binds one end of at least one of the second electrode plate and the second separation film.

Where a first end and a second end which is opposite to the first end is defined for each of the least one of the first electrode plate, the first separation film, the second electrode plate and the second separation film, the binding member may include a first binding member which binds the first end of at least one of the first electrode plate and the first separation film, and a second binding member which binds the second end of at least one of the second electrode plate and the second separation film.

The binding member may bind a central portion of the first and second electrode plates and the first and second separation films.

According to another exemplary embodiment, an electrochemical device includes an electrode assembly disposed in an external member. The electrode assembly includes: at least one first electrode plate; at least one second electrode plate facing the at least one first electrode plate; a first separation film of which a surface thereof is bonded to the at least one first electrode plate which faces the at least one second electrode plate; and a second separation film of which a surface thereof is bonded to the at least one second electrode plate which faces the at least one first electrode plate. The first separation film and the second separation film of which surfaces thereof are respectively bonded to the first electrode plate and the second electrode plate, are disposed between the first and second electrode plates facing each other.

A bonding of the first electrode plate to the first separation film and a bonding of the second electrode plate to the second separation film may include an adhesive layer disposed between a respective electrode plate and a respective separation film or a direct bond between a respective electrode plate and a respective separation film.

The electrode assembly may further include at least one third separation film between the first separation film and the second separation film disposed between the first and second electrode plates facing each other.

The electrode assembly may further include a protection layer on an outer surface of at least one of the first and second electrode plates.

The electrode assembly may further include a binding member which binds a portion of at least one of the first electrode plate, the first separation film, the second electrode plate and the second separation film.

The binding member may bind: one end of at least one of the first electrode plate and the first separation film, the binding member which binds the one end of the least one of the first electrode plate and the first separation film further binding one end of at least one of the second electrode plate and the second separation film, or where a first end and a second end which is opposite to the first end is defined for each of the least one of the first electrode plate, the first separation film, the second electrode plate and the second separation film, the binding member includes: a first binding member which binds the first end of at least one of the first electrode plate and the first separation film, and a second binding member which binds the second end of at least one of the second electrode plate and the second separation film, or a central portion of the first and second electrode plates and the first and second separation films.

### BRIEF DESCRIPTION OF THE DRAWINGS

These and/or other features will become apparent and more readily appreciated from the following description of the exemplary embodiments, taken in conjunction with the accompanying drawings in which:

FIG. 1 is a plan view of an electrode assembly according to an exemplary embodiment;

FIG. 2 is a cross-sectional view taken along line I-I′ of FIG. 1;

FIGS. 3A to 3F are diagrams illustrating examples of bonding areas defined on a surface of each of first and second separation films in the electrode assembly of FIGS. 1 and 2;

FIG. 4 is a cross-sectional view illustrating a state in which the electrode assembly of FIGS. 1 and 2 is bent;

FIG. 5 is a cross-sectional view of an electrode assembly according to another exemplary embodiment;

FIG. 6 is a cross-sectional view of an electrode assembly according to another exemplary embodiment;

FIG. 7 is a cross-sectional view of an electrode assembly according to another exemplary embodiment;

FIG. 8 is a cross-sectional view of an electrode assembly according to another exemplary embodiment; and

FIG. 9 is a cross-sectional view of an electrode assembly according to another exemplary embodiment.

### DETAILED DESCRIPTION

Reference will now be made in detail to exemplary embodiments, examples of which are illustrated in the accompanying drawings, where like reference numerals refer to like elements throughout. In this regard, the exemplary embodiments may have different forms and should not be construed as being limited to the descriptions set forth herein. Accordingly, the exemplary embodiments are merely described below, by referring to the figures, to explain features of the invention.

As used herein, the term “and/or” includes any and all combinations of one or more of the associated listed items. Expressions such as “at least one of,” when preceding a list of elements, modify the entire list of elements and do not modify the individual elements of the list.

Like reference numerals denote like elements throughout the specification and drawings. In the drawings, the dimensions of structures are exaggerated for clarity of the invention. It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

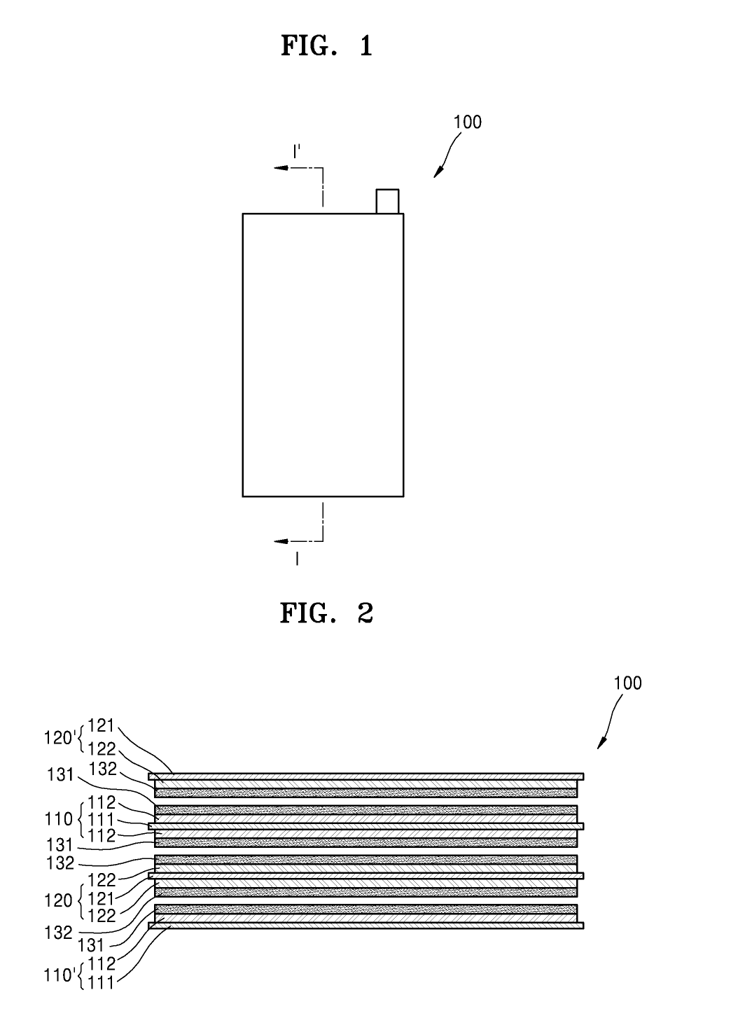

FIG. 1 is a plan view of an electrode assembly 100 according to an exemplary embodiment. FIG. 2 is a cross-sectional view taken along line I-I′ of FIG. 1. FIG. 2 illustrates a state in which the electrode assembly 100 is not bent.

Referring to FIGS. 1 and 2, the electrode assembly 100 may have a structure in which a plurality of first electrode plates 110 and 110′ on which are disposed first separation films 131, and a plurality of second electrode plates 120 and 120′ on which are disposed second separation films 132, are alternately stacked within the electrode assembly 100. Specifically, the plurality of first electrode plates 110 and 110′ and the plurality of second electrode plates 120 and 120′ are alternately stacked within the electrode assembly 100. The first separation films 131 are bonded to each of the first electrode plates 110 and 110′, and the second separation films 132 are bonded to each of the second electrode plates 120 and 120′. The first and second electrode plates 110, 110′, 120 and 120′ and the first and second separation films 131 and 132 may each include sheets having relatively small thicknesses. The sheets may include or be formed of a flexible material. Thus, the electrode assembly 100 as including the flexible material sheet has a flexible property.

One among the collection of the first electrode plates 110 and 110′ and the collection of the second electrode plates 120 and 120′ may be a collection of positive electrode plates and the other may be a collection of negative electrode plates. Specifically, when the first electrode plates 110 and 110′ are the positive electrode plates, the second electrode plates 120 and 120′ may be the negative electrode plates. Conversely, when the first electrode plates 110 and 110′ are the negative electrode plates, the second electrode plates 120 and 120′ may be the positive electrode plates.

The first electrode plates 110 and 110′ may each include a first current collector 111 and a first electrode active material layer 112 which is disposed on the first current collector 111. One or more of the first electrode active material layer 112 may be disposed on the first current collector 111 within a first electrode plate 110 and 110′. The first current collector 111 of the stack of the electrode assembly 100 may be exposed to outside the stack. Referring to FIG. 2, within the first electrode plate 110 disposed inside or at an inner area of the stack of the electrode assembly 100, first electrode active material layers 112 may be disposed on opposing surfaces of the first current collector 111. In the first electrode plate 110′ disposed outside or at an outer area of the stack of the electrode assembly 100, the first electrode active material layer 112 may be disposed on only one surface among opposing surfaces of the first current collector 111.

The second electrode plates 120 and 120′ may each include a second current collector 121 and a second electrode active material layer 122 which is disposed on the second current collector 121. One or more of the second electrode active material layer 122 may be disposed on the second current collector 121 within a second electrode plate 120 and 120′. The second current collector 121 of the stack of the electrode assembly 100 may be exposed to outside the stack. Referring to FIG. 2, within the second electrode plate 120 disposed inside the electrode assembly 100, the second electrode active material layer 122 may be disposed on opposing surfaces of the second current collector 121. In the second electrode plate 120′ disposed outside the electrode assembly 100, the second electrode active material layer 122 may be disposed on only one surface among the opposing surfaces of the second current collector 121.

When the first electrode plates 110 and 110′ are the positive electrode plates and the second electrode plates 120 and 120′ are the negative electrode plates, the first current collector 111 may be a positive current collector and the first electrode active material layer 112 may be a positive electrode active material layer. The second current collector 121 may be a negative current collector and the second electrode active material layer 122 may be a negative electrode active material layer.

The positive current collector may include at least one metal selected from aluminum, stainless steel, titanium, copper and silver. The positive electrode active material layer may include a positive electrode active material, a binder and a conductive material. In a lithium secondary battery, the positive electrode active material layer may include a material that is capable of reversibly occluding and discharging lithium ions.

The positive electrode active material of the positive electrode active material layer may include at least one material selected from lithium transition metal oxide (for example, lithium cobalt oxide, lithium nickelate, lithium nickel cobalt oxide, lithium nickel cobalt aluminum oxide, lithium nickel cobalt manganese oxide, lithium manganese oxide and iron phosphate lithium), nickel sulphide, copper sulfide, sulfur, iron oxide, and vanadium oxide.

The binder of the positive electrode active material layer may include at least one material selected from a polyvinylidene fluoride-based binder (for example, polyvinylidene fluoride, vinylidene fluoride/hexafluoropropylene copolymer, vinylidene fluoride/tetrafluroethylene copolymer), a carboxymethyl cellulose-based binder (for example, sodium carboxymethyl cellulose and lithium carboxymethyl cellulose), an acrylate-based binder (for example, anpolyacrylic acid, lithium-polyacrylic acid, acryl, polyacrylonitrile, polymethylmethacrylate, and polybutylacrylate), polyamide-imide, polytetrafluoroethylene, polyethylene oxide, polypyrrole, lithium-Nafion, and styrene-butadiene rubber-based polymer.

The conductive material of the positive electrode active material layer may include at least one material selected from a carbon-based conductive material (for example, a carbon black, a carbon fiber, and graphite), a conductive fiber (for example, a metal fiber), a metal powder (for example, a carbon fluoride powder, an aluminum powder, and a nickel powder), a conductive whisker (for example, zinc oxide and potassium titanate), a conductive metal oxide (for example, titanium oxide), and a conductive polymer (for example, polyphenylene derivative).

The negative current collector may include at least one metal selected from copper, stainless steel, nickel, aluminum, and titanium. The negative electrode active material layer may include a negative electrode active material, a binder and a conductive material. In the lithium secondary battery, the negative electrode active material layer may include a material that is capable of alloying with lithium or reversibly occluding and discharging lithium ions.

The negative electrode active material of the negative electrode active material layer may include at least one metal selected from a metal, a carbon-based material, metal oxide, and lithium metal nitride. The metal may include at least one material selected from lithium, silicon, magnesium, aluminum, germanium, tin, arsenic, antimony, bismuth, silver, gold, zinc, cadmium, mercury, copper, iron, nickel, cobalt and indium. The carbon-based material may include at least one material selected from graphite, a graphite carbon fiber, coke, mesocarbon microbeads (“MCMB”), polyacene, a pitch-based carbon fiber and hard carbon. The metal oxide may include at least one selected from lithium titanium oxide, titanium oxide, molybdenum oxide, niobium oxide, iron oxide, tungsten oxide, tin oxide, amorphous tin composite oxide, silicon monoxide, cobalt oxide and nickel oxide.

The binder and the conductive material of the negative electrode active material layer may include the same materials as those of the binder and the conductive material of the positive electrode active material, respectively.

The first and second separation films 131 and 132 may be provided between first electrode plates 110 and 110′ and second electrode plates 120 and 120′ respectively adjacent to each other within the stack of the electrode assembly 100. The first and second separation films 131 and 132 may electrically separate the first electrode plates 110 and 110′ and the second electrode plates 120 and 120′ adjacent to each other from one another. The first and second separation films 131 and 132 may include a porous polymer film such as a polyethylene film or a polypropylene film, a woven fabric or non-woven fabric including a polymer fiber, a ceramic particle, or a polymer solid electrolyte. However, the invention is not limited thereto.

A surface of the first separation film 131 is bonded to a surface of the first electrode plates 110 and 110′ facing an adjacent second electrode plate among the second electrode plates 120 and 120′. More specifically, the surface of the first separation film 131 is bonded to the first electrode active material layer 112 of the first electrode plates 110 and 110′. A surface of the second separation film 132 is bonded a surface of to the second electrode plates 120 and 120′ facing an adjacent first electrode plate among the first electrode plates 110 and 110′. More specifically, the surface of the second separation film 132 is bonded to the second electrode active material layer 122 of the second electrode plates 120 and 120′. Here, a first separation film 131 may be bonded to each of opposing surfaces of the first electrode plate 110 disposed at an inside of the electrode assembly 100, and a first separation film 131 may be bonded to one surface among opposing surfaces of the first electrode plate 110′ disposed at an outside of the electrode assembly 100. A second separation film 132 may be bonded to each of opposing surfaces of the second electrode plate 120 disposed at an inside of the electrode assembly 100, and a second separation film 132 may be bonded to one surface among opposing surfaces of the second electrode plate 120′ disposed at an outside of the electrode assembly 100.

In an exemplary embodiment, the bonding of the first electrode plates 110 and 110′ to the first separation film 131 and the bonding of the second electrode plates 120 and 120′ to the second separation film 132 may be performed by disposing adhesive layers (not illustrated) on surfaces of the first and second separation films 131 and 132 and respectively bonding the first and second electrode plates 110, 110′, 120 and 120′ to the surfaces of the first and second separation films 131 and 132, on which the adhesive layers are disposed, such as by using a predetermined bonding apparatus. In another exemplary embodiment, the bonding of the first electrode plates 110 and 110′ to the first separation film 131 and the bonding of the second electrode plates 120 and 120′ to the second separation film 132 may also be performed by using a direct bonding process such as heat welding. The bonding of the first and second separation films 131 and 132 to the various electrode plates fixes a position of the first and second separation films 131 and 132 relative to the various electrode plates to which they are bonded.

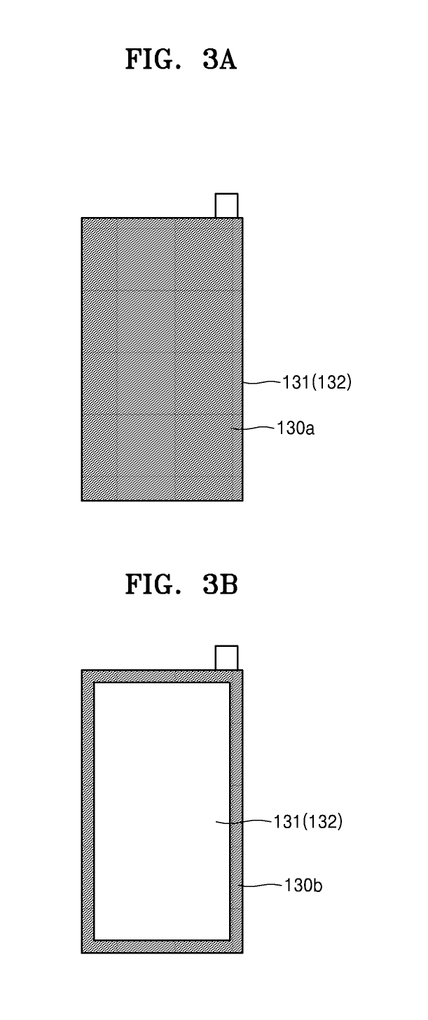

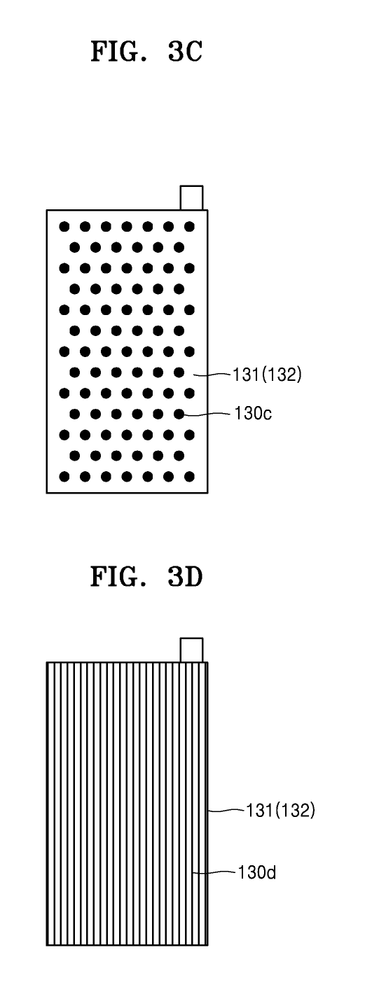

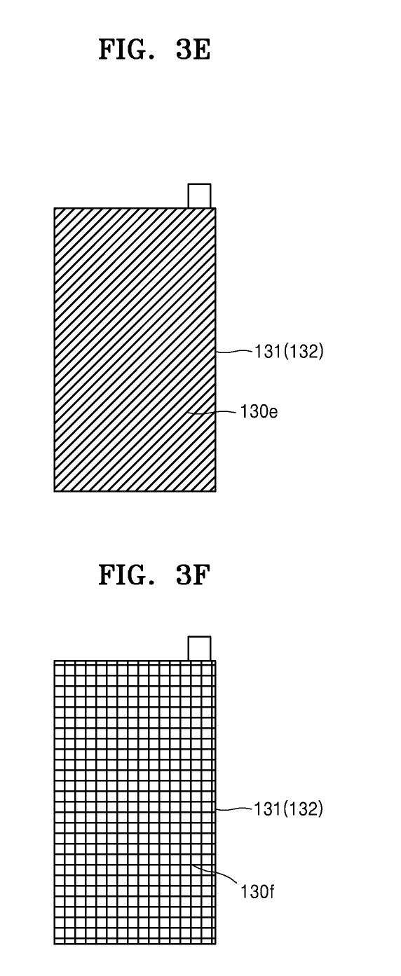

A bonding area, in which the bonding is actually performed between the first electrode plates 110 and 110′ and the first separation film 131 (or between the second electrode plates 120 and 120′ and the second separation film 132), may be defined entirely or partially on a surface of the first separation film 131 (or the second separation film 132). FIGS. 3A to 3F are diagrams illustrating examples of bonding areas 130a to 130f defined on a surface of each of the first separation film 131 (or the second separation film 132) in the electrode assembly 100 of FIGS. 1 and 2. While the following description refers to the first separation film 131, it is understood that the description also refers to the second separation film 132 (as indicated by ‘(132)’ shown in each of FIGS. 3A to 3F.

FIG. 3A illustrates a bonding area 130a defined on an entirety of one surface of the first separation film 131. FIG. 3B illustrates a bonding area 130b defined only at an edge portion on a surface of the first separation film 131, such that the surface of the first separation film 131 on which the first separation film 131 is not disposed is exposed by the bonding area 130b.

FIG. 3C illustrates a collective bonding area defined by a plurality of discrete bonding areas 130c each having the shape of a dot pattern on a surface of the first separation film 131, to expose portions of the surface of the first separation film 131 on which the bonding areas 130c are not disposed.

FIG. 3D illustrates a collective bonding area defined by a plurality of discrete bonding areas 130d each having a stripe pattern on a surface of the first separation film 131 to expose portions of the surface of the first separation film 131 on which the bonding areas 130d are not disposed. In FIG. 3D, the electrode assembly 100 has a long side extended in a vertical direction and a short side extended in a horizontal direction. The stripe pattern bonding areas 130d have lengths extended in the vertical direction to define a vertical stripe pattern, but the invention is not limited thereto. Alternatively, the stripe pattern bonding areas 130d may have lengths extended in the horizontal direction to define a horizontal stripe pattern on a surface of the first separation film 131. FIG. 3E illustrates a collective bonding area defined by a plurality of bonding areas 130e each having an inclined stripe pattern on a surface of the first separation film 131.

FIG. 3F illustrates a bonding area 130f is defined to have a crossed stripe pattern on a surface of the first separation film 131. In an exemplary embodiment the bonding areas 130d and 130e may be combined in any of a number of ways to form a crossed stripe pattern 130f.

The bonding areas 130a to 130f illustrated in FIGS. 3A to 3F are merely exemplary, and the bonding areas of the first separation film 131 (or the second separation film 132) may be formed with various pattern shapes.

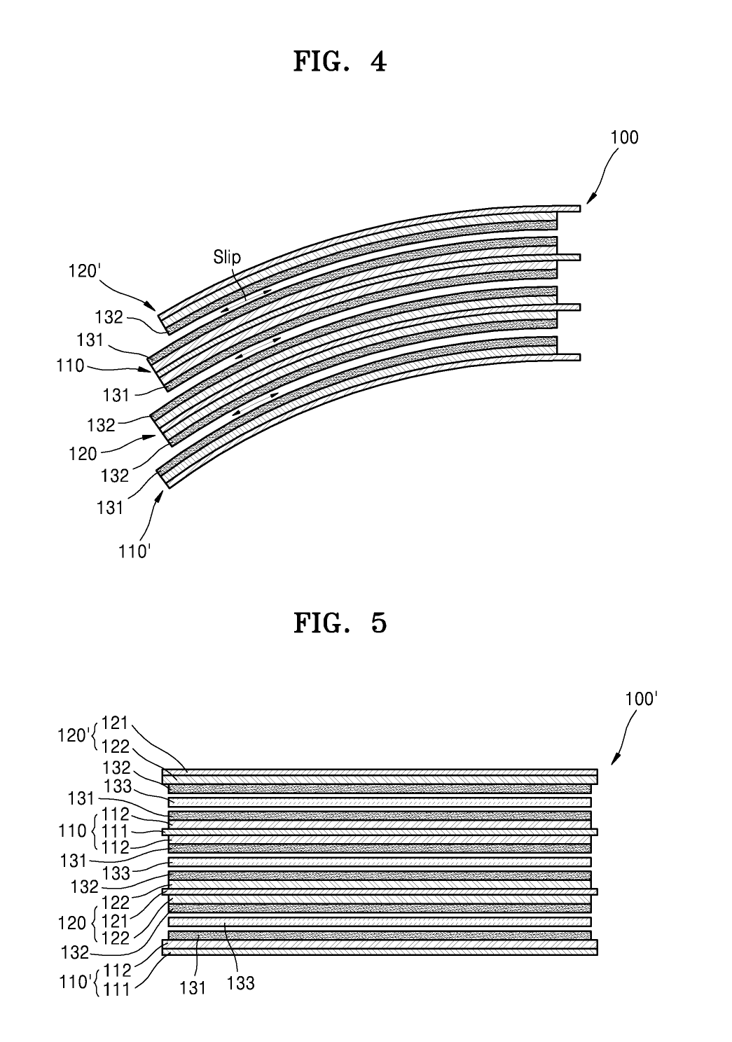

FIG. 4 is a cross-sectional view illustrating a state in which the electrode assembly 100 of FIGS. 1 and 2 is bent.

Referring to FIG. 4, when the electrode assembly 100 is bent from an un-bent state thereof, a slip occurs between the first separation film 131 and the second separation film 132. Since one surface of the first separation film 131 is bonded to the first electrode plates 110 and 110′ and one surface of the second separation film 132 is bonded to the second electrode plates 120 and 120′, no slip occurs between the first electrode active material layer 112 of the respective one first electrode plates 110 and 110′ and the first separation film 131 bonded thereto, and no slip occurs between the second electrode active material layer 122 of the respective one of the second electrode plates 120 and 120′ and the second separation film 132 bonded thereto, even when the electrode assembly 100 is bent. In addition, no slip occurs between the first electrode active material layer 112 and the second separation film 132 and between the second electrode active material layer 122 and the first separation film 131. That is, when the electrode assembly 100 is bent, a slip occurs only between the first separation film 131 and the second separation film 132. Thus, deterioration or damage to the active material layers from secession or grinding of the active material layers which may be caused by the respective slipping of the first and second separation films 131 and 132 with respect to the first and second electrode active material layers 112 and 122 is reduced or effectively prevented, thereby improving the durability of the electrode assembly 100.

In addition, since a slip occurs only between the first separation film 131 and the second separation film 132, an electrical short circuit between the first electrode plates 110 and 110′ and the second electrode plates 120 and 120′ which may be caused by misalignment of the electrode assembly 100 is reduced or effectively prevented, thereby improving the stability of the electrode assembly 100. As described above, where the electrode assembly 100 is packaged within an exterior material member together with an electrolyte, an electrochemical device such as a lithium secondary battery including the aforementioned components may be manufactured with improved durability and stability.

While an exemplary embodiment including two first electrode plates 110 and 110′ and two second electrode plates 120 and 120′ are alternately stacked within an electrode assembly 100 has been described above, the invention is not limited thereto. The number of the first electrode plates 110 and 110′ and the number of the second electrode plates 120 and 120′ may be variously changed within the electrode assembly 100.

FIG. 5 is a cross-sectional view of an electrode assembly 100′ according to another exemplary embodiment.

The electrode assembly 100′ of FIG. 5 differs from the electrode assembly 100 of FIG. 2 in that a third separation film 133 is further provided between the first separation film 131 and the second separation film 132 adjacent to each other. One third separation film 133 is provided between the first separation film 131 and the second separation film 132 adjacent to each other is illustrated in FIG. 5, but the invention is not limited thereto. In an exemplary embodiment, for example, a plurality of third separation films 133 may be provided between a single pair of the first separation film 131 and the second separation film 132 adjacent to each other.

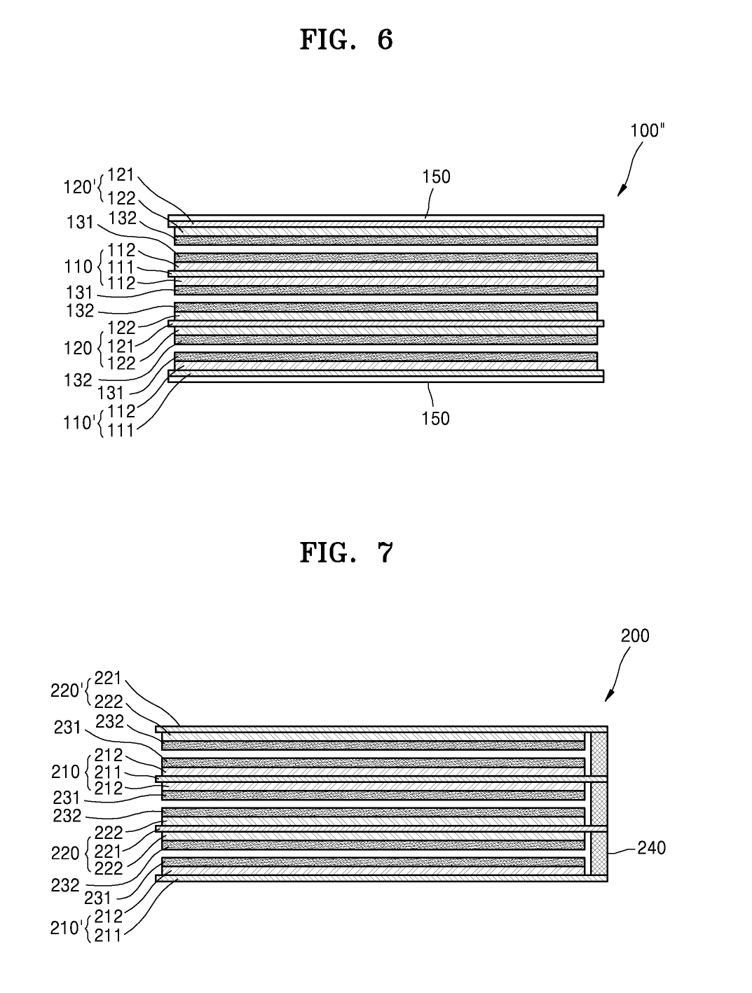

FIG. 6 is a cross-sectional view of an electrode assembly 100″ according to another exemplary embodiment.

The electrode assembly 100″ of FIG. 6 differs from the electrode assembly 100 of FIG. 2 in that protection layers 150 are further provided on outer surfaces of the first and second electrode plates 110′ and 120′. The protection layers 150 protect the first and second electrode plates 110, 110′, 120 and 120′ and the first and second separation films 131 and 132 from external physical impact or chemical influence thereto.

The protection layers 150 may include a material having sufficient flexibility and stiffness to have a negligible influence on the bending of the first and second electrode plates 110, 110′, 120 and 120′ and the first and second separation films 131 and 132. A bending stiffness of the protection layer 150 may be greater than an average bending stiffness of the individual layers constituting the electrode assembly 100″, that is, the first and second electrode plates 110, 110′, 120 and 120′ and the first and second separation films 131 and 132. In an exemplary embodiment, for example, the bending stiffness of the protection layer 150 may be equal to or greater than about 1.5 times the average bending stiffness of the first and second electrode plates 110, 110′, 120 and 120′ and the first and second separation films 131 and 132. In addition, the protection layer 150 may have a thickness in a cross-section direction of about 15 micrometers (μm) to about 1 millimeter (mm). The protection layer 150 may have a tensile modulus of elasticity in the range of about 0.5 gigapascal (GPa) to about 300 gigapascals (GPa). However, the invention is not limited thereto. The protection layer 150 may be a polymer film, a film including a laminated polymer film layer, a metal foil, or a composite film including carbon.

FIG. 7 is a cross-sectional view of an electrode assembly 200 according to another exemplary embodiment.

Referring to FIG. 7, the electrode assembly 200 may have a stack structure and a binding member 240 attached to the stack structure. In the stack structure, a plurality of first electrode plates 210 and 210′ on which first separation films 231 are disposed and a plurality of second electrode plates 220 and 220′ on which second electrode plates 232 are disposed are alternately stacked. The binding member 240 binds a first end of the stack structure. The binding of the first end of the stack structure fixes a position of first ends of one or more layers to which the binding member 240 is bound. The second (distal) ends of the one or more layers of the stack structure are not bound and positions thereof are not fixed relative to each other.

One among the collection of the first electrode plates 210 and 210′ and the collection of the second electrode plates 220 and 220′ may be a collection of positive electrode plates and the other may be a collection of negative electrode plates.

The first electrode plates 210 and 210′ may each include a first current collector 211 and a first electrode active material layer 212 which is disposed on the first current collector 211. One or more of the first electrode active material layer 212 may be disposed on the first current collector 211 within a first electrode plate 210 and 210′. The first current collector 211 of the stack of the electrode assembly 200 may be exposed to outside the stack. Referring to FIG. 7, within the first electrode plate 210 disposed inside or at an inner area of the stack of the electrode assembly 200, first electrode active material layers 212 may be disposed on opposing surfaces of the first current collector 211. In the first electrode plate 210′ disposed outside or at an outer area of the stack of the electrode assembly 200, the first electrode active material layer 212 may be disposed on only one surface among opposing surfaces of the first current collector 211.

The second electrode plates 220 and 220′ may each include a second current collector 221 and a second electrode active material layer 222 which is disposed on the second current collector 221. One or more of the second electrode active material layer 222 may be disposed on the second current collector 221 within a second electrode plate 220 and 220′. The second current collector 221 of the stack of the electrode assembly 200 may be exposed to outside the stack. Referring to FIG. 7, within the second electrode plate 220 disposed inside the electrode assembly 200, the second electrode active material layer 222 may be disposed on opposing surfaces of the second current collector 221. In the second electrode plate 220′ disposed outside the electrode assembly 200, the second electrode active material layer 222 may be disposed on only one surface among the opposing surfaces of the second current collector 221.

A pair of the first and second separation films 231 and 232 may be provided between first electrode plates 210 and 210′ and second electrode plates 220 and 220′ respectively adjacent to each other within the stack of the electrode assembly 200. A surface of the first separation film 231 is bonded to a surface of the first electrode plates 210 and 210′ facing an adjacent second electrode plate among the second electrode plates 220 and 220′, and a surface of the second separation film 232 is bonded to a surface of the second electrode plates 220 and 220′ facing an adjacent first electrode plate among the first electrode plates 210 and 210′. Here, a first separation film 231 may be bonded to each of opposing surfaces of the first electrode plate 210 disposed at an inside of the electrode assembly 200, and a surface of the first separation film 231 may be bonded to one surface among opposing surfaces of the first electrode plate 210′ disposed at an outside of the electrode assembly 200. A surface of the second separation film 232 may be bonded to each of opposing surfaces of the second electrode plate 220 disposed at an inside of the electrode assembly 200, and a surface of the second separation film 232 may be bonded to one surface among opposing surfaces of the second electrode plate 220′ disposed at an outside of the electrode assembly 200.

In an exemplary embodiment, the bonding of the first electrode plates 210 and 210′ to the first separation film 231 and the bonding of the second electrode plates 220 and 220′ to the second separation film 232 may be performed by disposing an adhesive layer or by using a direct bonding process. In addition, a bonding area, in which the bonding is actually performed between the first electrode plates 210 and 210′ and the first separation film 231 (or between the second electrode plates 220 and 220′ and the second separation film 232), may be defined on a entirety of or a portion of a surface of the first separation film 231 (or the second separation film 232).

The binding member 240 is provided at a first end of the electrode assembly 200. The binding member 240 may bind one end of each of the first and second electrode plates 210, 210′, 220 and 220′ so as to fix a position of the first ends of the first and second electrode plates 210, 210′, 220 and 220′ relative to each other. The binding member 240 may be provided using an adhesive or an adhesive-coated tape, but is not limited thereto. The binding member 240 may be provided by using other various methods. The binding member 240 binds one (first) end of each of the first electrode plates 210 and 210′ to which the first separation films 231 are bonded and one (first) end of each of the second electrode plates 220 and 220′ to which the second separation films 232 are bonded.

Among the layers forming the first and second electrode plates 210, 210′, 220 and 220′, an exemplary embodiment in which first ends of the first current collectors 211 of the first electrode plates 210 and 210′ and first ends of the second current collectors 221 of the second electrode plates 220 and 220′ are bound by the binding member 240 is illustrated in FIG. 7. In another exemplary embodiment, however, first ends of the first electrode active material layers 212 of the first electrode plates 210 and 210′ and first ends of the second electrode active material layer 222 of the second electrode plates 220 and 220′ may be bound by the binding member 240. In still another exemplary embodiment, first ends of each of the first current collectors 211 and the first electrode active material layers 212 of the first electrode plates 210 and 210′ and first ends of each of the second current collectors 221 and the second electrode active material layers 222 of the second electrode plates 220 and 220′ may be bound by the binding member 240.

As described above, since the binding member 240 binds one end of each of the first and second electrode plates 210, 210′, 220 and 220′, maintaining the alignment of the individual layers constituting the electrode assembly 200 is possible. In addition, as described above, when the electrode assembly 200 is bent, a slip occurs only between the first separation film 231 and the second separation film 232. Thus, secession or grinding of the active material layers is reduced or effectively prevented, thereby improving the durability and stability of the electrode assembly 200.

So far, an exemplary embodiment in which one end of only of the first and second electrode plates 210, 210′, 220 and 220′ is bound by the binding member 240 has been described. However, the invention is not limited thereto. In an exemplary embodiment, a first end of each of the first and second separation films 231 and 232 may be bound by the binding member 240, without first ends of the first and second electrode plates 210, 210′, 220 and 220′ being bound. In an alternative exemplary embodiment, one (first) end of each of the first and second electrode plates 210, 210′, 220 and 220′ and one (first) end of each of the first and second separation films 231 and 232 may be bound together by the binding member 240. In addition, as described above, at least one third separation film (refer to FIG. 5) may be further provided between the first separation film 231 and the second separation film 232 inside the electrode assembly 200, and a protection layer (refer to FIG. 6) may be further formed outside the electrode assembly 200. The third separation film and/or the protection layer may be bound or may be un-bound by the binding member 240 in various combinations.

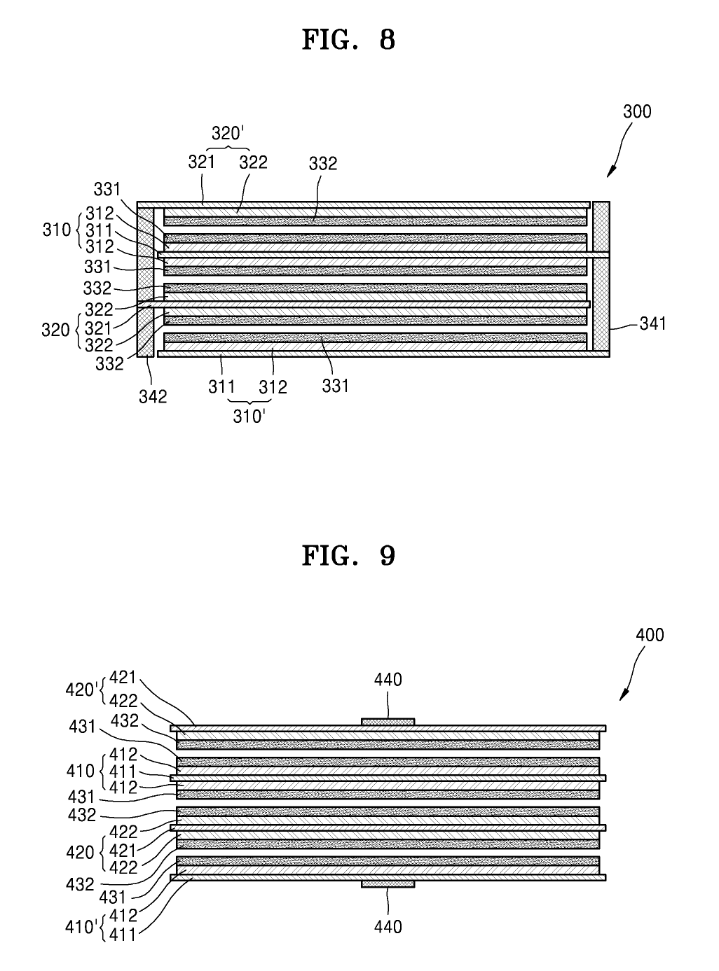

FIG. 8 is a cross-sectional view of an electrode assembly 300 according to another exemplary embodiment.

Referring to FIG. 8, the electrode assembly 300 may have a stack structure and a collective binding member. In the stack structure, a plurality of first electrode plates 310 and 310′ on which first separation films 331 are disposed and a plurality of second electrode plates 320 and 320′ on which second electrode plates 332 are disposed are alternately stacked. The collective binding member binds opposing first and second ends of the stack structure.

The first electrode plates 310 and 310′ may each include a first current collector 311 and a first electrode active material layer 312 which is disposed on the first current collector 311. One or more of the first electrode active material layer 312 may be disposed on the first current collector 311 within a first electrode plate 310 and 310′. The first current collector 311 of the stack of the electrode assembly 300 may be exposed to outside the stack. The second electrode plates 320 and 320′ may each include a second current collector 321 and a second electrode active material layer 322 which is disposed on the second current collector 321. One or more of the second electrode active material layer 322 may be disposed on the second current collector 321 within a second electrode plate 320 and 320′. The second current collector 321 of the stack of the electrode assembly 300 may be exposed to outside the stack.

A pair of the first and second separation films 331 and 332 may be provided between first electrode plates 310 and 310′ and second electrode plates 320 and 320′ respectively adjacent to each other within the stack of the electrode assembly 300. A surface of the first separation film 331 is bonded to a surface of the first electrode plates 310 and 310′ facing an adjacent second electrode plate among the second electrode plates 320 and 320′, and a surface of the second separation film 332 is bonded to a surface of the second electrode plates 320 and 320′ facing a first electrode plate among the first electrode plates 310 and 310′.

The bonding of the first electrode plates 310 and 310′ to the first separation film 331 and the bonding of the second electrode plates 320 and 320′ to the second separation film 332 may be performed by disposing an adhesive layer or by using a direct bonding process. In addition, a bonding area, in which the bonding is actually performed between the first electrode plates 310 and 310′ and the first separation film 331 (or between the second electrode plates 320 and 320′ and the second separation film 332), may be defined on an entirety of or a portion of a surface of the first separation film 331 (or the second separation film 332).

The collective binding member includes a first binding member 341 binding first ends of each of the first electrode plates 310 and 310′, and a second binding member 342 binding second ends opposing the first ends of each of the second electrode plates 320 and 320′. Among the layers forming the first and second electrode plates 310, 310′, 320 and 320′, FIG. 8 illustrates an exemplary embodiment in which first ends of the first current collectors 311 of the first electrode plates 310 and 310′ are bound by the first binding member 341, and second ends of the second current collectors 321 of the second electrode plates 320 and 320′ are bound by the second binding member 342. In another exemplary embodiment, however, first ends of the first electrode active material layers 312 of the first electrode plates 310 and 310′ may be bound by the first binding member 341, or first ends of each of the first current collectors 311 and the first electrode active material layers 312 of the first electrode plates 310 and 310′ may be bound by the first binding member 341. In addition, second ends of the second electrode active material layers 322 of the second electrode plates 320 and 320′ may be bound by the second binding member 342, or second ends of each of the second current collectors 321 and the second electrode active material layers 322 of the second electrode plates 320 and 320′ may be bound by the second binding member 342.

So far, an exemplary embodiment in which first ends of only each of the first electrode plates 310 and 310′ is bound by the first binding member 341 and second ends of only each of the second electrode plates 320 and 320′ is bound by the second binding member 342. However, in another exemplary embodiment, first ends of only the first separation films 331 may be bound by the first binding member 341, or first ends of each of the first electrode plates 310 and 310′ and first ends of the first separation films 331 may be bound by the first binding member 341. In addition, second ends of only the second separation films 332 may be bound by the second binding member 342, or second ends of each of the second electrode plates 320 and 320′ and second ends of the second separation films 332 may be bound by the second binding member 342. In addition, as described above, at least one third separation film (refer to FIG. 5) may be further provided between the first separation film 331 and the second separation film 332 inside the electrode assembly 300, and a protection layer (refer to FIG. 6) may be further formed outside the electrode assembly 300. The third separation film and/or the protection layer may be bound or may be un-bound by the first and second binding members 341 and 342 in various combinations.

FIG. 9 is a cross-sectional view of an electrode assembly 400 according to another exemplary embodiment.

Referring to FIG. 9, the electrode assembly 400 may have a stack structure and a binding member 440. In the stack structure, a plurality of first electrode plates 410 and 410′ on which first separation films 431 are disposed and a plurality of second electrode plates 420 and 420′ on which second electrode plates 432 are disposed are alternately stacked. The binding member 440 binds a central portion of the stack structure.

The first electrode plates 410 and 410′ may each include a first current collector 411 and a first electrode active material layer 412 which is disposed on the first current collector 411. One or more of the first electrode active material layer 412 may be disposed on the first current collector 411 within a first electrode plate 410 and 410′. The first current collector 411 of the stack of the electrode assembly 400 may be exposed to outside the stack. The second electrode plates 420 and 420′ may each include a second current collector 421 and second electrode active material layer 422 which is disposed on the second current collector 421. One or more of the second electrode active material layer 422 may be disposed on the second current collector 421 within a second electrode plate 420 and 420′. The second current collector 421 of the stack of the electrode assembly 400 may be exposed to outside the stack.

A pair of the first and second separation films 431 and 432 may be provided between first electrode plates 410 and 410′ and second electrode plates 420 and 420′ respectively adjacent to each other within the stack of the electrode assembly 400. A surface of the first separation film 431 is bonded to a surface of the first electrode plates 410 and 410′ facing a second electrode plate among the second electrode plates 420 and 420′, and a surface of the second separation film 432 is bonded to a surface of the second electrode plates 420 and 420′ facing a first electrode plate among the first electrode plates 410 and 410′.

The bonding of the first electrode plates 410 and 410′ to the first separation film 431 and the bonding of the second electrode plates 420 and 420′ to the second separation film 432 may be performed by disposing an adhesive layer or by using a direct bonding process. In addition, a bonding area, in which the bonding is actually performed between the first electrode plates 410 and 410′ and the first separation film 431 (or between the second electrode plates 420 and 420′ and the second separation film 432), may be defined on an entirety of or on a portion of a surface of the first separation film 431 (or the second separation film 432).

Among the layers within the electrode assembly 400, the binding member 440 binds the layers to each other at a central portion of each of the first electrode plates 410 and 410′ to which the first separation films 431 are bonded and at a central portion of each of the second electrode plates 420 and 420′ to which the second separation films 432 are bonded. The exemplary embodiment in which the binding member 440 is provided to surround the outside of the electrode assembly 400 is illustrated in FIG. 8, but the exemplary embodiment is not limited thereto. A binding member (not illustrated) may be provided at the central portion of the electrode assembly 400 to pass through an inside of the electrode assembly 400. In addition, as described above, at least one third separation film (refer to FIG. 5) may be further provided between the first separation film 431 and the second separation film 432, and a protection layer (refer to FIG. 6) may be further formed outside the electrode assembly 400. The third separation film and/or the protection layer may be bound or may be un-bound by the binding member 440 in various combinations.

As described above, according to one or more of the above-described exemplary embodiments, since the first and second separation films respectively bonded to the first and second electrode plates are provided between the first electrode plate and the second electrode plate adjacent to each other, a slip occurs only between the first separation film and the second separation film when the electrode assembly is bent. Therefore, secession or grinding of the active material layers which may be caused by the slip between the separation film and the electrode active material layer of the electrode plate may be reduced or effectively prevented, thereby improving the durability of the electrode assembly. In addition, since no slip occurs between the active material layers and the separation films, an occurrence of an electrical short circuit between the first electrode plate and the second electrode plate which may be caused by misalignment of the electrode assembly is reduced or effectively prevented, thereby improving the stability of the electrode assembly. Furthermore, since the binding member binds a portion of each of the first and second electrode plates to fix positions thereof relative to each other, the alignment of the individual layers constituting the electrode assembly may be maintained. Where any one of the above-described exemplary embodiments of an electrode assembly is packaged within an exterior material member together with an electrolyte, an electrochemical device such as a lithium secondary battery with improved durability and stability may be manufactured.

It should be understood that the exemplary embodiments described therein should be considered in a descriptive sense only and not for purposes of limitation. Descriptions of features within each exemplary embodiment should typically be considered as available for other similar features in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An electrode assembly comprising:
at least one first electrode plate;
at least one second electrode plate facing the at least one first electrode plate;
a first separation film of which a surface thereof is bonded to the at least one first electrode plate which faces the at least one second electrode plate; and
a second separation film of which a surface thereof is bonded to the at least one second electrode plate which faces the at least one first electrode plate,
wherein the first separation film and the second separation film of which surfaces thereof are respectively bonded to the first electrode plate and the second electrode plate, are disposed between the first and second electrode plates facing each other.

2. The electrode assembly of claim 1, wherein the first electrode plate and the second electrode plate each have flexibility.

3. The electrode assembly of claim 1, wherein each of the first electrode plate and the second electrode plate comprises:
a current collector, and
an electrode active material on at least one surface of the current collector.

4. The electrode assembly of claim 1, wherein the bonding of the first electrode plate to the first separation film and the bonding of the second electrode plate to the second separation film comprises an adhesive layer disposed between a respective electrode plate and a respective separation film or a direct bond between a respective electrode plate and a respective separation film.

5. The electrode assembly of claim 1, wherein
for the first separation film bonded to the first electrode plate, a bonding area is defined on at least a portion of the surface of the first separation film which is bonded to the first electrode plate, and
for the second separation film bonded to the second electrode plate, a bonding area is defined on at least a portion of the surface of the second separation film which is bonded to the second electrode plate.

6. The electrode assembly of claim 1, further comprising at least one third separation film between the first separation film and the second separation film disposed between the first and second electrode plates facing each other.

7. The electrode assembly of claim 1, further comprising a protection layer on an outer surface of at least one of the first and second electrode plates.

8. The electrode assembly of claim 7, wherein a bending stiffness of the protection layer is greater than an average bending stiffness of the first and second electrode plates and of the first and second separation films.

9. The electrode assembly of claim 1, further comprising a binding member which binds a portion of at least one of the first electrode plate, the first separation film, the second electrode plate and the second separation film.

10. The electrode assembly of claim 9, wherein
the binding member binds one end of at least one of the first electrode plate and the first separation film, and
the binding member which binds the one end of the least one of the first electrode plate and the first separation film further binds one end of at least one of the second electrode plate and the second separation film.

11. The electrode assembly of claim 9, wherein where a first end and a second end which is opposite to the first end is defined for each of the least one of the first electrode plate, the first separation film, the second electrode plate and the second separation film, the binding member comprising:
a first binding member which binds the first end of at least one of the first electrode plate and the first separation film, and
a second binding member which binds the second end of at least one of the second electrode plate and the second separation film.

12. The electrode assembly of claim 9, wherein the binding member binds a central portion of the first and second electrode plates and the first and second separation films.

13. An electrochemical device comprising:
an electrode assembly disposed in an external member,
the electrode assembly comprising:
at least one first electrode plate;
at least one second electrode plate facing the at least one first electrode plate;
a first separation film of which a surface thereof is bonded to the at least one first electrode plate which faces the at least one second electrode plate; and
a second separation film of which a surface thereof is bonded to the at least one second electrode plate which faces the at least one first electrode plate,
wherein the first separation film and the second separation film of which surfaces thereof are respectively bonded to the first electrode plate and the second electrode plate, are disposed between the first and second electrode plates facing each other.

14. The electrochemical device of claim 13, wherein the bonding of the first electrode plate to the first separation film and the bonding of the second electrode plate to the second separation film comprises an adhesive layer disposed between a respective electrode plate and a respective separation film or a direct bond between a respective electrode plate and a respective separation film.

15. The electrochemical device of claim 13, wherein the electrode assembly further comprises at least one third separation film between the first separation film and the second separation film disposed between the first and second electrode plates facing each other.

16. The electrochemical device of claim 13, wherein the electrode assembly further comprises a protection layer on an outer surface of at least one of the first and second electrode plates.

17. The electrochemical device of claim 13, wherein the electrode assembly further comprises a binding member which binds a portion of at least one of the first electrode plate, the first separation film, the second electrode plate and the second separation film.

18. The electrochemical device of claim 17, wherein
the binding member binds one end of at least one of the first electrode plate and the first separation film, the binding member which binds the one end of the least one of the first electrode plate and the first separation film further binding one end of at least one of the second electrode plate and the second separation film, or
where a first end and a second end which is opposite to the first end is defined for each of the least one of the first electrode plate, the first separation film, the second electrode plate and the second separation film, the binding member comprises:
a first binding member which binds the first end of at least one of the first electrode plate and the first separation film, and
a second binding member which binds the second end of at least one of the second electrode plate and the second separation film, or
the binding member binds a central portion of the first and second electrode plates and the first and second separation films.

19. The electrochemical device of claim 13, wherein the electrode assembly further comprises:
the first and second separation films provided in plural; and
a plurality of the first electrode plates alternately disposed with a plurality of the second electrode plates.
